(19) United States
(12) Patent Application Publication
(10) Pub. No.: US 2026/0271815 A1
(43) Pub. Date: Sep. 17, 2026

(54) Farm Machinery Implement Pulling and Power Solutions

(71) Applicants: Senake ATURELIYA, London, Greater London (GB); DOGBOT TECHNOLOGY LIMITED, London, Greater London (GB)

(72) Inventor: Senake Atureliya, London (GB)

(21) Appl. No.: 19/472,787

(22) PCT Filed: Jun. 1, 2024
(86) PCT No.: PCT/GB2024/051432

§ 371 Date: Oct. 6, 2025

(30) Foreign Application Priority Data
Apr. 11, 2023 (GB) GB2305313.5
Apr. 12, 2023 (GB) GB2305340.8
Jun. 3, 2023 (GB) GB2308328.0
Aug. 22, 2023 (GB) GB2312836.6
Sep. 3, 2023 (GB) GB2313418.2
Sep. 27, 2023 (GB) GB2314827.3

(51) Int. Cl. A01B 3/72; A01B 3/66

(52) U.S. Cl. CPC A01B 3/72; A01B 3/66

(57) ABSTRACT

Farm implement pulling apparatus and related enhancements.

### BACKGROUND

The majority of our food is produced on open farmland using heavy diesel powered machinery. Whilst single purpose machines such as combine harvesters are used for some tasks, the majority of operations such as cultivating or ploughing, seeding, spreading of fertiliser, spraying of insecticides and herbicides are carried out by purpose built implements which are towed behind farm tractors.

There is significant demand for less energy intensive and polluting tractors however fulfilling this demand is proving difficult due to the high power requirements needed to both pull the implements through the soil as well as and propel both them and the tractor over the uneven and sometime sloping ground.

Electrification could reduce energy as efficiency are much higher than that of diesel drivetrains but high battery cost and comparatively low energy density mean that capital cost and working duration are uncompetitive compared to existing machines. Tractors need to be able to operate for the long working days to undertake operations in season and within the limited good weather conditions windows.

Vehicle weight reduction would also increase efficiency. This would also reduce the need for frequent ploughing as the ground would be less compacted. Unfortunately weight is also required to achieve the necessary wheel or track to ground and frictional forces needed to counteract the significant pulling force used to pull the implement.

This inventions seeks to improve on current farm solutions.

The apparatus described in this document proposes the use of ground anchors and row end top up charging to enable extreme efficiency increases and enable electrification for carbon emissions reduction. It is based around a multiplicity of pulling units the size and weight of which have been reduced by utilising ground anchors as opposed to wheel to tyre friction. The pulling units move a predetermined distance away from the implements and before attaching themselves to the ground with anchors and then using a multiplicity of winches to pull the multiplicity of farm implements towards them.

### ELEMENTS OF THE INVENTION

According to one embodiment of this invention the apparatus for pulling farm implements comprises of a multiplicity of pulling vehicles that utilise ground anchors rather than wheel to ground friction to achieve the traction required and winches to apply the force required to pull farm implements across a farm field towards them.

According to a preferred version of this invention some or all of the anchors are inclined at an angle to the ground such that they are driven into it by the pulling forces of the winch cables rather than being dislodged by them.

According to one version of this invention in order to minimise the energy needed to drive the anchors into the ground to provide the required resistance for implement pulling the anchors are in the form of a multiplicity spiral drills rotated and inserted into the ground.

According to a preferred version of this invention the active drill anchors are mounted within hollow passive ground anchors to minimise the risk of them bending by maximising the chance that they are deployed into hard ground so that they encounter mainly shear force rather than bending moments.

According to a preferred version of this invention the vehicles are autonomous so that no drivers cab is required on the vehicle.

According to a preferred version of this invention the anchors will be tapered and shaped to create conical or frustram shaped holes in the ground so that any frictional or suction forces that must be counteracted when retrieving the anchors by pulling them out along their axis are minimised.

According to a preferred version of this invention a multiplicity of winches connected to the pulling vehicle frames by winch cables are mounted on the farm implement to enable multiple winch drums to be driven by a common rotary actuator and shaft with relative speeds being achieved using a multiplicity of clutches or gearboxes or variable speed control mechanisms combinations of these components.

According to a preferred version of this invention the multiplicity of winch drums with cables that connect them to the multiplicity of ground anchor equipped implement pulling vehicles are mounted on a multiplicity of frames that themselves are attached to the farm implement.

According to a preferred version of this invention the implement mounted frames incorporate quick release mechanisms to minimise the time and effort required to transfer them between different farm implements.

According to a preferred version of this invention the quick release mechanisms that engage with components at can be retrofitted to them implement.

Advantageously the features described above enable significant simplification and weight reduction of the pulling vehicles compared to existing farm tractors.

According to a preferred version of this invention the pulling vehicles would incorporate actuators such as electric motors that are powered by onboard energy storage devices such as batteries or supercapacitors or internal combustion engine powered generators.

According to a one version of this invention the pulling vehicles would incorporate a multiplicity of internal combustion engines powered by onboard energy stored in liquid or gaseous or solid fuel tanks.

According to a preferred version of this invention where the pulling vehicles and farm implements are partially or fully electrically powered another manned or autonomous vehicle would deliver charged batteries or supercapacitors to them the vehicle and optionally the implement whilst also removing partially or full discharged units which it would then take to a multiplicity of fixed charging points for recharging.

According to a preferred version of this invention in order to minimise the distance that the charging vehicle need to travel the pulling vehicles and farm implements would happen when they reached the top of the field or were turning around to go back down the field.

According to an alternative version of this invention the supercapacitors or battery on the implement towing vehicle would be charged up by it docking with a multiplicity of mains connected or topped up mobile charging stations that move along a track on the farm field fence.

According to a preferred version of this invention the electrical components on implement may be supplied up via cables from the towing vehicle or charged up when the two dock together.

According to an alternative version of this invention batteries may be used to replace or supplement some or all of the supercapacitors used in the solution.

Advantageously the autonomous vehicle and farm fence top up charging solutions described would enable electrification of the pulling vehicles and farm implements with further energy savings achieved by improved efficiencies compared to diesel drivetrains.

According to a preferred version of this invention the farm implement would be fitted with a multiplicity of wheels some of which are swivelling and others which are not to enable direction changes whilst still providing directional control when moving over uneven and smooth ground.

According to a preferred version of this invention the implement mounted power steerable wheels incorporate disc or spikes or plates sections that protrude past the flat or tyre surfaces which can dig into unmade ground to reduce slipping or skidding of the wheels.

Advantageously these protruding disc or spike or plate equipped wheels would only be located on sections of the implement that are folded upwards during non farm field movement so as not to damage the wheels or hard surface that the implement is moved over.

According to a preferred version of this invention the ground anchor equipped pulling units are equipped with a multiplicity of tracked units mounted at an angle to the horizontal plane to enable them to climb over obstacles when moving across rough terrain whilst remaining compact with small diameter wheels and minimising turning friction by keeping the ground contact patch similar to that of a wheel.

According to a preferred version of this invention the multiplicity of implement mounted steerable and optionally height adjustable wheels or tracked units are also motorised so that they can use the weight of the implement to provide the required wheel to ground frictional force to move the implement either with or without the help of the ground anchor equipped pulling mechanisms.

According to a preferred version of this invention some or all of the passive ground anchors have a rectangular cross section and are inserted so that their largest flat surface faces the implement to maximise the component of resistive pulling force that the anchor provides compared to an anchor with an elliptical or circular cross section.

Advantageously the winch drum and cable would be positioned close to the ground to minimise any turning moments that would result in forces with components that act along axis that pull or twist the anchors out of the ground.

According to a preferred version of this invention to help enable an implement pulling vehicle to undertake a turn it would incorporate a ground anchor installed at an angle that is more perpendicular to the ground or closer to a vertical axis around which the unit and vehicle or machine to which it is attached could rotate.

According to a preferred version of this invention the frameworks connecting the implement pulling vehicles into co joined units referred to as implement tow bars are positioned at a height that allows them to straddle fully grown crops enabling so that they be used for late growing season activities such as pulling spray bars or sensors or harvesting implements.

According to a preferred version of this invention to minimise the time when the farm implement is not moving a second set of tow bars would move past the anchoring positions of the first set and deploy their anchors whilst the first set is winching in the implements so that it can winch in the implement whilst first set is repeating the process.

According to an alternative version of this invention where the shape and actuator format of the tow bars allows them to travel over the top of or underneath one another this would enable all of them to be linked together by rigid or flexible jointing frameworks or cables.

According to a preferred version of this invention the implement pulling vehicles will be narrow enough to travel in the gaps between crop rows to reduce or eradicate the need for non planted areas commonly known as tramlines that are left for wider tractor or sprayer or combine harvester tyres to roll over.

According to a preferred version of this invention some or all of the frameworks connecting the implement pulling vehicles are pivoting mechanisms and actuating mechanisms such as cables would facilitate the angle between these components to be changed so that the distance between the implement pulling vehicles can be set to match crop row or tramlines spacings in different fields and on different farms.

According to a preferred version of this invention in order to minimise the risk of damage these pivoting mechanisms and actuating mechanisms would accommodate horizontal or vertical misalignment between the implement pulling units as a result of them moving over uneven ground or implement pulling activity.

According to a preferred version of this invention the implement tow bar would be foldable to enable it to move through narrow openings and along narrow roadways.

According to one version of this invention some of the wheels or tracks on the implement pulling vehicle would incorporate height adjustment mechanisms to lift the non rotating and rotating anchors components clear of the ground when the unit is being moved on its wheels.

According to a preferred version of this invention the implement pulling vehicles would incorporate mechanisms to retract both the non rotating and rotating anchors components when the unit is being moved on its wheels.

According to a preferred version of this invention the mechanism used to deploy and retrieve the ground anchors would incorporate a means such as an actuator or cam to twist them in the ground to overcome static friction or suction force before attempting to withdrawing them or whilst withdrawing them.

According to a preferred version of this invention to minimise risk of injury or damage the width of the frontal area of the multiplicity of ground anchor equipped pulling vehicles and their interconnecting members would be minimised so that a person or animal could easily move out of their way into the space between them.

According to a preferred version of this invention to further minimise risk of injury or damage the frontal area of the ground anchor equipped pulling mechanisms and any interconnecting members and the system frames mounted on the implement would be fitted with energy absorbing and deformable components such as shaped foam pieces.

According to a preferred version of this invention the winch cables used would be made of a material with low elasticity and potential energy storage capacity to minimise risk of injury or damage in the event that they breaks.

According to a preferred version of this invention the winch cables would incorporate some longer strands that were not in tension when the cable was pulling the implement such that in the event of a break these longer strands would keep the loose ends together and stop them from moving significantly away from the original cable path and causing injury or damage in the event that they breaks.

According to a one version of this invention the implement tow bar would be capable of folding to form a trailer unit which could be pulled by a farm tractor or other vehicle. According to another version of this invention the tow bar can fold into a mobile vehicle unit that can move under its own power around a farm or along a road as well as in a field.

According to a preferred version of this invention the implement tow bar will use actuator powered rotation and steering of the multiplicity of wheels or tracks on its connected implement towing vehicles to facilitate folding and unfolding and width adjustment actions.

According to a preferred version of this invention the height of the tow bars and towed implements and top up charging vehicle would be minimised to facilitate the farming of crops beneath or within lower height structures than is currently possible.

According to a preferred version of this invention the towed implements would be drawn up close to and rigidly docked with the pulling vehicles and actuators would lift the implements tools off the ground to enable non linear motion such as that needed to turn around at the end of a set of farm field furrows or generally move around farms or on roads to be undertaken under the vehicles driven wheel power alone.

According to a preferred version of this invention in order to fulfil the functionality of the farm tractor mechanical rotary drive provided to power towed implements that is commonly referred to as a power take off the implement would be fitted with its own electrically powered actuators supplied with energy from either by swappable supercapacitors mounted upon it or via cables from the implement pulling vehicle.

According to an alternative version of this invention the implement pulling mechanism comprising of a beam with a multiplicity of ground anchoring units and cable winched mounted along its length would be fitted to the towing connection of a typical farm tractor or robot or other vehicle to enable it to move a predetermined distance away from the multiplicity of towable farm implements such as cultivators or seed drills or sprayers whilst still remaining attached to them by the winch cables and after deploying the anchors to attach itself to the ground it uses the winches to wind in the cables to pull the multiplicity of farm implements closer to itself.

According to a preferred version of this invention the tow bar would be fitted with a multiplicity of wheels along its weight to support some or all of its weight.

According to one version of this invention the implement is pulled from a central towing point located along its width by a single cable.

According to a preferred version of this invention where the vehicle is significantly narrower than the implements that it is used to tow guidance and optionally some pulling force would be provided by a multiplicity of at least two cables attached to the ends of the implement whilst a third central cable was used to pull it inward for docking and optionally also exert towing force.

Advantageously the cables to constrain the rotation about the hitch implement pulling mechanism about the farm tractor or robot or vehicle would be attached to its extremities to provide optimal leverage against turning moments.

Advantageously where required to clear its wheel or other components the farm tractor or robot or vehicle would be fitted with components such as cross beams to extend the location of extremities further from its axis of travel.

According to a preferred version of this invention to enable a towbar to pull an implement along a non linear path by shortening the winch cables on some of the pulling vehicles more than others to cope with the change in direction of the pulling force there would be a multiplicity of arms that radiate outward from the main body of the drive unit in different directions with ground anchors fixed to them.

According to a one version of this invention the drive units have a multiplicity of winches mounted on a multiplicity of arms that radiate outward from the body of the drive unit but which are rigidly fixed to it.

According to another version of this invention the drive units have a multiplicity of winches mounted on a multiplicity of arms that radiate outward from the body of the drive unit but which can jointly or individually swivel around it.

According to a preferred version of this invention the drive units have a multiplicity of winch cable drum that rotate around their body from which the winch cables can be pulled in any direction and optionally additional anchors on the radial arms orientated that act to prevent the rotation of the drive unit bodies or the machine or vehicle to which they are fixed.

According to a preferred version of this invention the ground anchors on the swivelling arms would be of the active actuated drill type so that instead of trying to be pulled out of the ground by the single direction motion of the vehicle or mobile machine they can be fully retracted by the drill moving mechanism in the all of the different directions in which they were inserted due to the different direction in which all of the arms are pointing.

This invention will now be illustrated by reference to the figures listed below.

For clarity some elements within the figures have been shown as transparent when they would actually be made of opaque material.

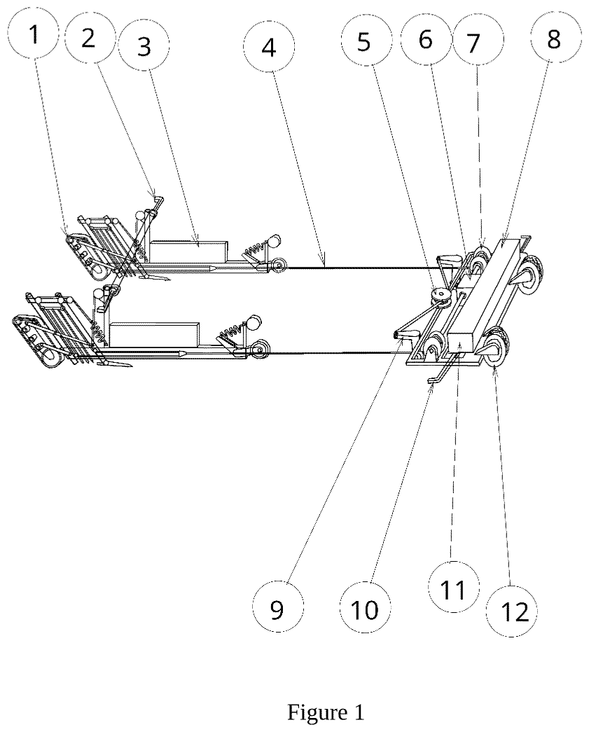

FIG. 1 shows a pair of mobile anchor units pulling a cultivating and seeding farm implement.

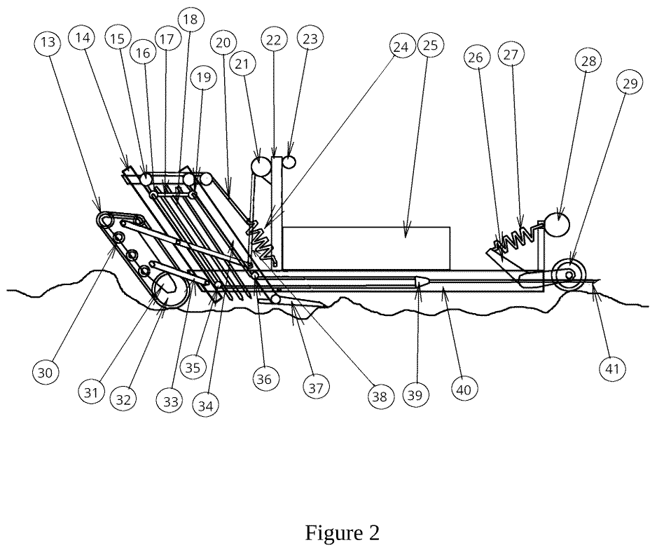

FIG. 2 shows the detailed side view of a mobile anchor unit with its temporary sliding anchors raised and its hinged anchor dragging along the ground as the unit moves away from the farm implement to which it is attached by winch cables.

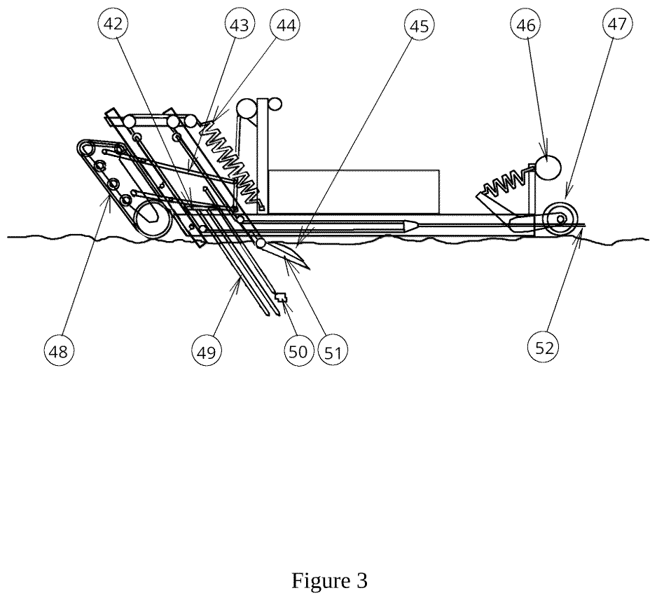

FIG. 3 shows a view of the same mobile anchor unit as in FIG. 2 but with its temporary sliding and hinged anchors deployed into the ground.

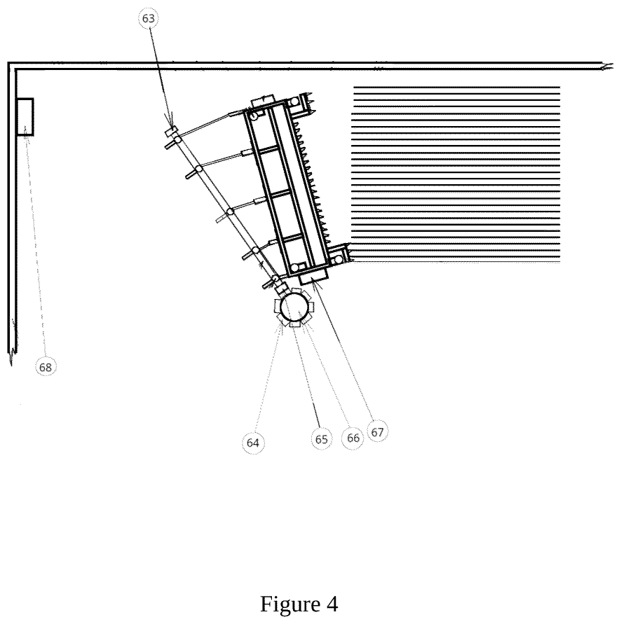

FIG. 4 shows an arrangement where five interlinked ground anchor equipped towing units which having pulled a farm implement across a field using winches is now carrying out what is commonly know as a headland turn with a mobile vehicle waiting to swap out its partially discharged batteries.

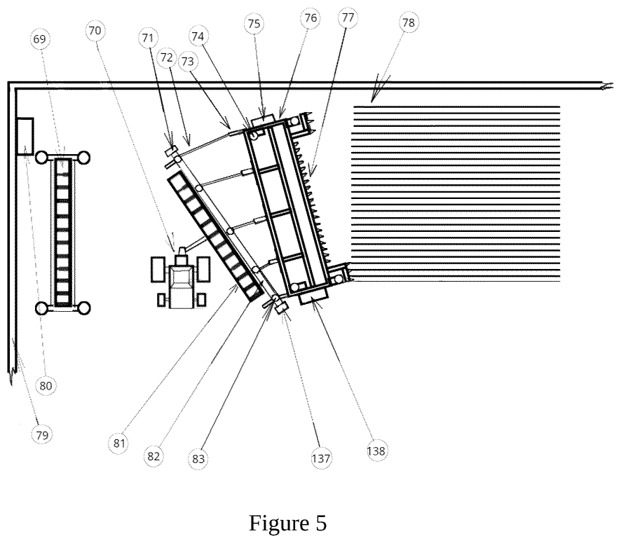

FIG. 5 shows a small tractor with a ground anchor and winch equipped tow bar pulling a farm implement around a headland turn whilst a mobile charging unit tops up its onboard energy stores.

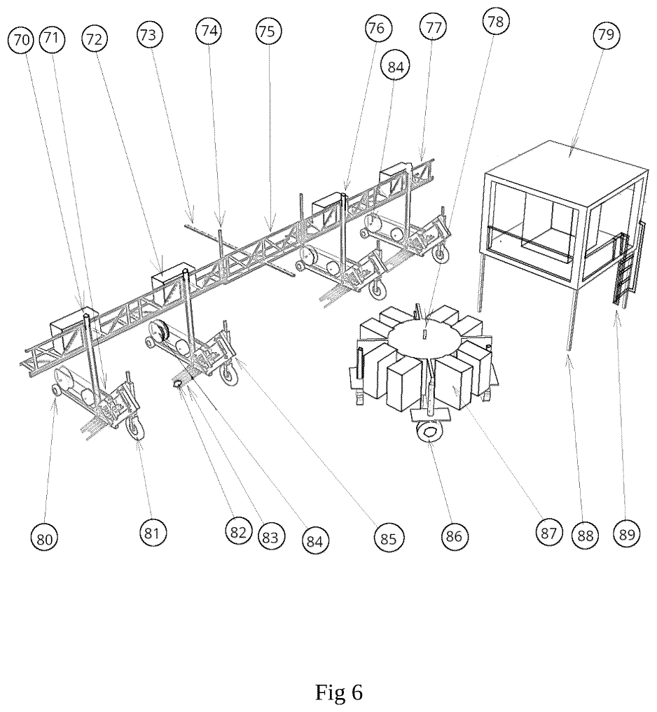

FIG. 6 shows the implement towbar in its fully open position with a top up charge vehicle and demounted operator control cab nearby.

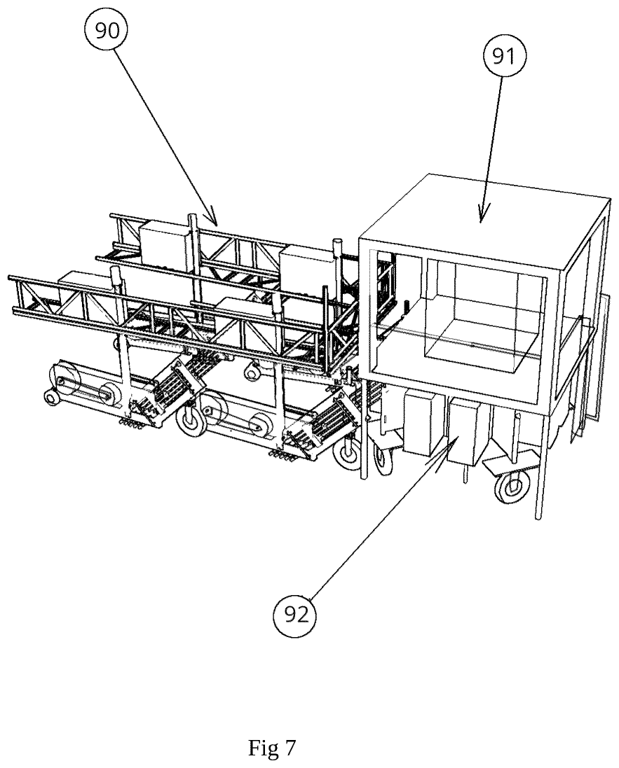

FIG. 7 shows the same implement towbar as in FIG. 1 in its folded position with the top up charge vehicle with the drivers cab mounted upon it as the drive unit to propel it around the farm or along the public road.

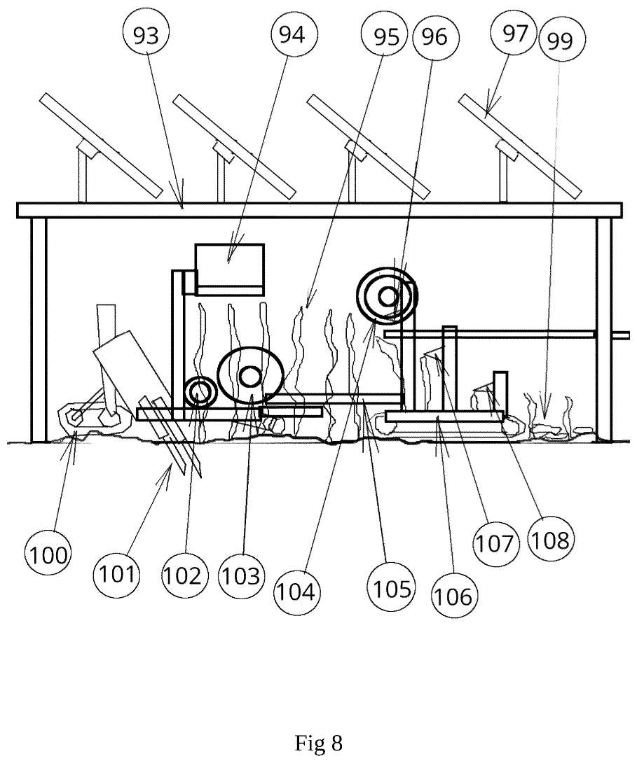

FIG. 8 shows a new form factor low height wheat or corn or soy bean harvesting implement being pulled by a tow bar moving under a solar panel support structure.

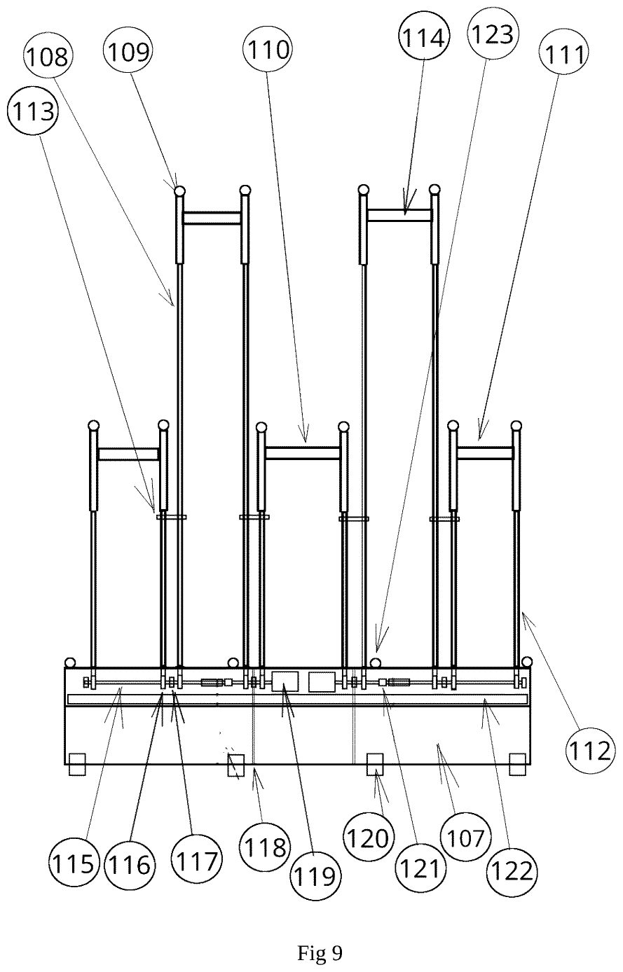

FIG. 9 shows an overhead view of farm implement pulling system with two sets of tow bars that take it in turns to pull the implement in as near continuous motion as possible.

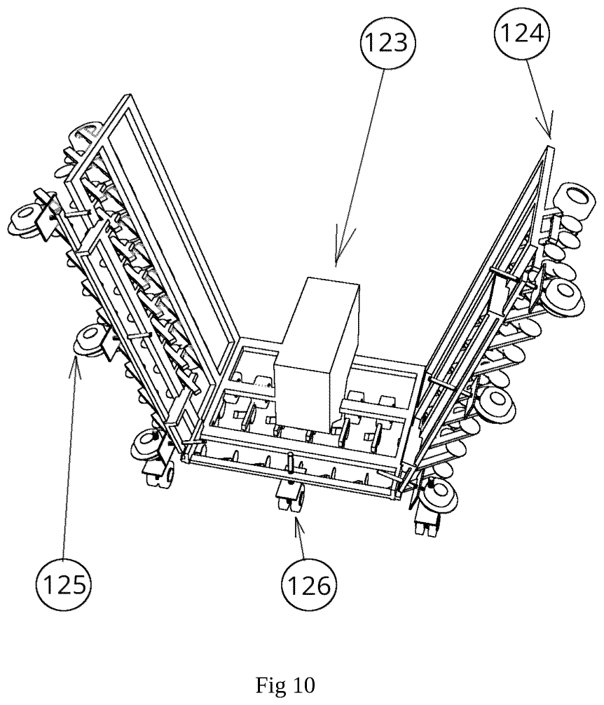

FIG. 10 shows a folding farm implement fitted with steerable guide wheels some of which that are located on the lifting have discs that protrude past the outer diameter of its tyres or flat rolling surfaces which dig into unmade ground to help with direction changes at high speed or on inclined ground.

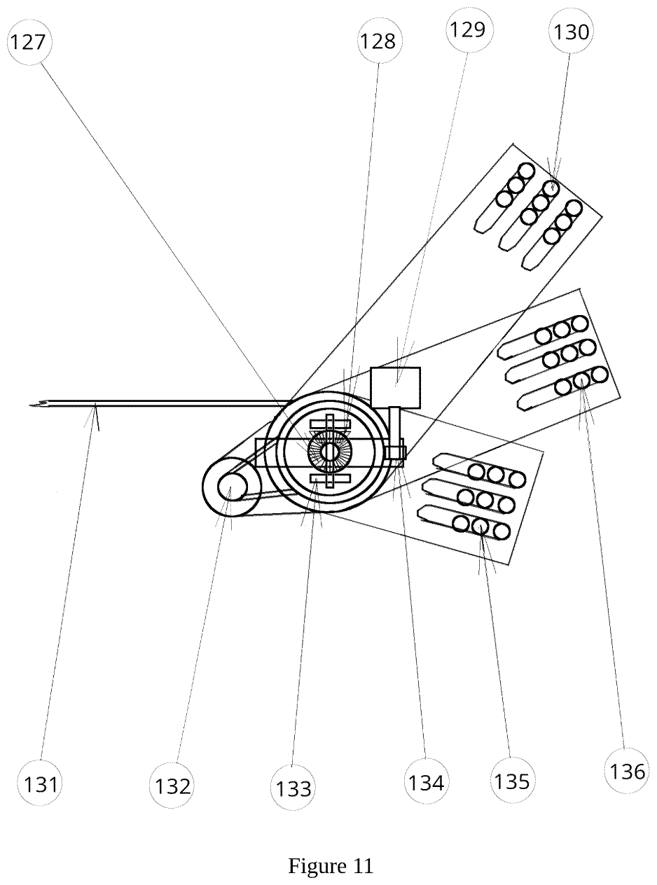

FIG. 11 shows a top view of a farm implement pulling unit unit with ground anchors mounted on radial arms and a winch drum incorporated around its body.

According to FIG. 1 there are a pair of farm implement pulling vehicles fitted with tracked propulsion units 1 connected by member 2 with joints that enable rotation about the member axis to accommodate differences in the slope of ground over which the implement pulling vehicles are travelling. The member 2 also has electrical charging pick up arms fitted to its ends which are used to enable the top up of the onboard supercapacitor and battery backs 3. Cables 4 are fed out by rotating winch cable drums 7 that are mounted upon a farm implement as the mobile implement pulling vehicles simultaneously move away into their respective pulling locations and then after they have deployed their anchors the winch cables are wound back in to pull the farm implement forward toward the pulling locations. The winch cable drums are independently turned by rotary actuators inside the enclosure 6. A centrally mounted motorised drum 5 is used to pull on arms to turn the steerable unpowered wheels or tracked units 9 which are obscured in this diagram to control the direction of the farm implement. Electrical pick up arms 10 are used to charge the supercapacitors and battery packs contained in the enclosure 8 which also houses the farm implement seed storage containers and control system. Non steerable wheels 12 on the back of the farm implement also help to support its weight.

According to FIG. 2 there is a farm implement pulling vehicle that moves across the ground powered by an inclined tracked unit which comprises of a rotary actuator 13 that engages with a rubber track 30 that follows a path around a lower idler roller 32 and other support rollers all of which are mounted to a subframe 31. The tracked unit is mounted to pivot points on the mobile anchor unit frame 14 via a two pairs of parallel upper and lower swing arms 33 one one each side of the tracked unit. Winches 21 with cables connected to the end of the upper swing arms are wound in or let out to alter the height of the mobile anchor unit from the ground. A hinged ground anchor 37 drags along the ground as the mobile anchor unit moves forward away from the farm implement to which it attached by winch cables 41. The rear of the mobile anchor unit is supported by a trailing wheel 29 the height of which can also be adjusted via the winch 29 which can be used to pull on or let out the control arm 26. A compression spring 27 also provides some degree of suspension travel reduce vibration as the mobile anchor unit travels over bumps. The lower ends of the three sliding ground anchors 17 pass through low friction bushes in the frame 14 that are not shown. The upper ends of the sliding anchors 17 pass through a sliding carriage 16 which has its ends mounted to rollers that move in guides fixed to the frame members 14 and 34. To enable the sliding anchors 17 to be extended downward the ends of the sliding carriage 16 are fixed to the end of the winch cable 41 via a splitter 39 that itself is connected to two cables which run through the captive guide pulleys 35 and 36 up the frame members 14 and 34. The sliding carriage 16 is also connected via the cables 20 that run through captive pulleys 15 at tops of the frame members 14 and 34 to a spring 24 that provides the force to retract the sliding anchors 17 upwards when the downwards winch cable force is removed. The member 23 which connects this mobile anchor unit to others is mounted in a swivelling joint at the top of the vertical frame member 22.

According to FIG. 3 the mobile anchor unit in FIG. 3 is shown with its hinged anchor 51 and sliding anchors 49 inserted into the ground. As the sliding anchors are extended into their downward position their retraction spring 44 is shown extended. The tip of the hinged anchor has carved out a void with a curved upper surface as its angle has changed during the process of it being driven into the ground. This anchor is shaped with a pointed bottom edge so that material can move from below to above it to fill the void as this happens. In order to enable the anchors to be pushed to their maximum depth the one that has hit a buried rock 50 has been pushed through the sliding carriage 42 against the force of a spring that is not shown. The tracked carriage has also been raised to its maximum height against the frame so that it does not need to withstand any diverted forces caused by the winch cable pulling the mobile anchor frame downward into the ground along the axis of the sliding anchors. To avoid damage to the trailing wheel 47 the cable from winch 46 has also let out to allow it to be pushed upwards by the diverted downward force on the mobile anchor frame.

According to FIG. 4 an autonomous charging vehicle 66 positions itself at one end of a set of interconnected implement pulling vehicles 69 as they execute what is commonly know as a headland turn at the top of a farm field so that it can charge the farm implement mounted batteries 63 from others 64 mounted around its body. Whilst docked with the farm implement another set of fixed batteries 73 on it are also be charged up at this time.

According to FIG. 5 there is a small autonomous electric tractor 70 pulling a tow bar 82 that is fitted with multiple self contained drive units 83 around a farm field. An autonomy system on the tow bar 71 uses GPS sensors 71 and 137 mounted on its ends to detect its absolute position and signal the tractor 70 to adjust its direction or stop so that it can deploy ground anchors when required. The tow bar 82 then pulls the farm implement 76 towards itself using the winch cables 72. Swivelling castor wheels 74 with power actuated steering are moved according to inputs from the sensors 75 and 138 on either ends of the farm implement to keep it moving along the desired path through the field without it being displaced by the uneven ground or other factors. When the farm implement 76 has completed a set of furrows 78 it is raised on the lifting units so that its tines or disc tools 77 are raised clear of the ground. This reduces the pulling force so that the tractor 70 can pull the tow bar 82 and farm implement 76 around the headland turn around under its own limited power. If this is not possible the tow bar 82 can assist the tractor 70 by deploying its anchors and pulling in the winch cables 72 in by different amounts across its width. A bank of supercapacitors or batteries 81 powers the actuators and sensors and winches as well as the implement as it creates furrows 78 whilst moving up and down the field. When the supercapacitors or batteries 81 are nearing a discharged state an autonomous vehicle 69 which has been fast charging a set of supercapacitors or batteries at a fixed charging point 80 mounted on the field fence 79 swaps them over with the set 81 on the tow bar 82 when it reaches the top of the field.

According to FIG. 6 there is a farm implement towing solution that comprises an extending frame 75 with two outer pivoting frames 77 connected to it by pivot poles 76 mounted upon four implement pulling vehicles 84. Each implement pulling vehicle has a number of rotating drill anchors 83 encased in fixed square cross section frustram shaped anchor sheaths 84 mounted in an actuator driven sliding frames 85. Motors with shafts that run down through the pivot poles 76 power the up and down movement of the ground anchors via a series of cables and pulleys. With the winches 84 set to freely let out cable the powered steerable and height adjustable front wheels 81 of the implement pulling vehicles 84 are used to lift the drill and sheath ground anchors 83 clear of the ground after which they move the implement pulling vehicles to desired positions in the field. The smaller diameter steerable wheels 80 support the back end of the implement pulling vehicles as they moves up the furrow between plants. The direction of the front wheels 81 to keep them between the planted rows is controlled by a camera which is not shown that is attached to a central control system. When the implement pulling vehicles reach a distance of around 50 metres from the implement they deploy their anchors 83 into the ground and activate the winches 84 to wind in their cables which are not shown in this diagram in order to pull the implement towards the. The pulling force exerted by the winch cabled drives the fixed sheath anchors down into the ground guided by the deeply lodged drill anchors. An operator oversees the operation of the tow bar from within his demounted cab 79 positioned on legs 88 at the edge of the field. They use the access ladder 89 to climb in or out of the cab as required. The actuators on the tow bar are powered from the supercapacitor storage devices 72. When the tow bar gets to the end of a furrow it will latch onto the top up charge vehicle 87 that has already sunk its own vertically orientated anchor 78 into the ground. The implement pulling vehicles will then winch in the implement so that a mating connector latches on to the end of the pivot pole end of the vertical anchor 78. Together the powered wheels 16 on the top up charge vehicle will turn the farm implement around the top up charge vehicle 87 and its vertical anchor 78. As this happens the supercapacitors on the tow bar 9 and others on the implement which are not shown will be topped up with power from supercapacitors on the top up charging vehicle 87. After the turn the pulling vehicles and implement will continue back up the field whist the top up charge vehicle recharges its supercapacitors at a fixed charging point.

According to FIG. 7 there is a farm implement towing solution 90 similar to that shown in FIG. 6 with its outer pivoting frames folded inward ready for transportation along roadways and through narrow gate. This is connected to the top up charging vehicle 91 which now has the drivers cab 92 mounted upon it. When towing the farm implement towing solution or farm implements between fields or along roads, motion is undertaken using just the powered wheels on the implement pulling vehicles in the folded towing solution 90 and on up charging vehicle 91.

According to FIG. 8 there is a harvesting implement 106 that moves under a framework 93 that is supporting four rows of solar panels 97. The implement 106 is pulled by a cable 105 that is being wound onto the winch cable drum 103 mounted upon an implement pulling vehicle that has previously moved into position using tracks 100 and has now deployed anchors 101 to temporarily secured in position on the ground. The winch cable drum 103 is turned by the motor 102. Both the winch motor and tracked unit are powered by the supercapacitor or battery 94 mounted at a height that enable it to straddle the wheat plants 95. As the harvesting implement moves forward the drum 104 is used to pulls the tips or ears of the wheat plants 95 up against pairs of oscillating hook teeth blades 73 that cut it off and harvest the seed which them drops onto the conveyor beneath. The blades 107 and 108 cut pieces 99 from the remaining part of the plants that drop onto the ground for mulching to enrich the soil.

According to FIG. 9 there is a farm implement 107 being pulled by two sets of ground anchor equipped and frame connected pulling vehicle pairs. One set comprises of two outer pulling vehicle pairs 111 and an inner pair 110 which pull the implement 107 forwards whilst another set comprising of the two inner pairs 109 and 114 simultaneously move past the first set and anchor themselves to the ground ready to pull the implement 107 when the winch cables 108 attached to the first set have reached a certain length. Winch motors 119 turn the winch drums 116 via a series of clutches 121 and concentric shafts 115 to wind pull or release the winch cables 112 are mounted on demountable frames that have been retrofitted to the central non folding and outer folding sections of the farm implement 107. When the outer wings of the implement 107 are folded upwards or downwards along the hinges 118 to accommodate road and between field transportation the winch drive shafts 115 which are mounted in the supporting pillow block bearings 117 have a multiplicity of universal joint and sliding splined sections along their length to accommodate the movement of the folding motion. Steerable and height adjustable driven wheels 123 are also included on the retrofitted frames to both guide the implement in the field whilst adjusting the depth by which ground contact implements move through the ground and also to help power it around the headland turn at the ends of the sets of furrows. Additional powered wheels on the retrofitted frame 120 can also be lowered to help push the implement in the field when required and adjust the depth by which ground contact implements move through the ground. Batteries and supercapacitor energy storage devices 122 to power the winch motors 119 and actuators for the steerable and height adjustable driven wheels 123 and 120 are also mounted on the retrofitted frames.

According to FIG. 10 there is a farm implement with a number of road wheels fitted with conventional tyres 126 mounted on a central section 123 as well as a number of steerable guide wheels 125 that incorporate discs that protrude past the outer diameter of its their tyres or flat rolling surfaces which are mounted upon outer upward folding sections 124 so that they can be lifted upwards when required for travel on roads and other paved areas. These discs help guide the implement by digging into unmade ground to exert forces to help with direction changes or keep the implement on a desired path on inclined ground. When being towed on roads or over hard surfaces the implement is folded up to reduce its width and its weight is supported solely by the wheels 126.

According to FIG. 11 there is a farm implement pulling unit with a motor 132 that turns a winch drum which rotates around the vertically orientated main body of the unit itself to wind or unwind a cable 131 connected to a farm implement which is not shown. Sets of three banks of ground anchors are mounted at the end of a long arm 130 and medium length arm 136 and a short arm 135 that radiate out from the body of the unit and which can be positioned at different angles around it to counteract the forces applied by the winch cable 131 as the load which is pulling moves around it. The arm angle adjustment is carried out by motors 129 via the pinion 134. When it is not being used to turn the winch drum the bevel gear 127 can be slid along the shaft of the motor 132 so that it can also be used to power the wheels 133 that move the farm implement pulling unit along the ground. Some parts of the implement pulling vehicle frame have been omitted for clarity to more clearly show the pulling unit element.

1. Apparatus that comprises of a multiplicity of pulling vehicles that utilise ground anchors rather than wheel to ground friction to achieve the traction and winches to apply the force required to pull farm implements towards them across a farm field.

2. The apparatus of claim 1, wherein when protruding from the pulling vehicle the anchors are inclined with respect to the ground so that when the winch cables are shortened some of the force that they exert is diverted to push the anchors down into the ground.

3. The apparatus of claim 1 or claim 2 wherein to reduce the force required to insert the anchors into the ground they are in the form of rotating drill bits.

4. The apparatus of claim 1 or claim 2, wherein to reduce horizontal slippage a multiplicity of rotating drill bits are first inserted into the ground through tubular anchors so that they act to guide the more rigid tubular anchors into the ground when a component of horizontal force acts upon them.

5. The apparatus of any of the claims 1 to 5, wherein some or all of the passive ground anchors have a rectangular rather than elliptical or circular cross section to maximise the component of resistive pulling force that the anchor.

6. The apparatus of any of the claims 1 to 5 wherein a mechanism on the implement pulling vehicles diverts force exerted by the winch cables to extend the anchor components downward out of the frame of the pulling vehicle in the required order.

7. The apparatus any of the claims 1 to 6 wherein some or all of the anchors are tapered and shaped to create conical or frustram shaped holes in the ground so that any frictional or suction forces that must be counteracted when retrieving the anchors by pulling them out along their axis are minimised.

8. The apparatus of claim 1 wherein the winch cable is positioned as close to the ground as possible to minimise any turning moments that would result in forces that act to pull or twist the anchors out of the ground.

9. The apparatus of claim 1, wherein some or all of winch drums and winch drum actuators and winch actuator energy storage devices are mounted upon the implement that is being pulled.

10. The apparatus of claim 1, wherein some or all of winch drums and winch drum actuators and winch actuator energy storage devices are mounted upon the implement pulling vehicles.

11. The apparatus of claim 1 which also comprises a multiplicity of subframes that can be retrofitted to the farm implements upon which a multiplicity of winches and winch actuators and winch actuator energy storage devices are mounted to enable the pulling of a multiplicity of different farm implements.

12. The apparatus of claim 1, wherein the implement mounted frames incorporate quick release mechanisms that engage with retrofit implement mounted components to minimise the time and effort required to transfer them between different farm implements.

13. The apparatus of claim 1, wherein multiple winch drums are driven by a common rotary actuator and shaft with relative speeds being achieved using a multiplicity of clutches or gearboxes or variable speed control mechanisms combinations of these components.

14. The apparatus of claim 1 which comprises a multiplicity of wheels fitted to the farm implement to enable direction changes and control when moving over uneven and smooth ground.

15. The apparatus of claim 14, wherein the implement mounted power steerable wheels incorporate disc or spikes or plates sections that protrude past the flat or tyre surfaces which can dig into unmade ground to reduce slipping or skidding of the wheels.

16. The apparatus of claim 15, wherein the protruding disc or spike or plate equipped wheels are only located on sections of the implement that are folded upwards during non farm field movement so as not to damage the wheels or hard surface that the implement is moved over.

17. The apparatus of claims 1, wherein the ground anchor equipped pulling units are equipped with a multiplicity of tracked units mounted at an angle to the horizontal plane to enable them to climb over obstacles when moving across rough terrain whilst remaining compact with small diameter wheels and minimising turning friction by keeping the ground contact patch similar to that of a wheel.

18. The apparatus of claims 14 to 16, wherein a multiplicity of implement mounted steerable and optionally height adjustable wheels or track units are motorised so that they can utilise the weight of the implement to provide the required wheel to ground frictional force to move the implement either with or without the help of the ground anchor equipped pulling mechanisms.

19. The apparatus of claims 1, wherein in order to help enable an implement pulling vehicle to undertake a turn it would incorporate a ground anchor installed into the ground at an angle that is more perpendicular to it or closer to a vertical axis around which the implement pulling vehicle and implement to which it is attached can rotate.

20. The apparatus of claims 1, wherein to minimise the time when the farm implement is not moving a second set of tow bars moves past the anchored positions of the first set of pulling units and deploys their anchors whilst the first set is winching in the implements so that they can winch in the implement whilst first set is repeating the process.

21. The method of claims 1, wherein the shape and format of the co-joined implement pulling vehicles connected by rigid or flexible frameworks or cables allows them to travel over the top of or underneath one another.

22. The apparatus of claims 1, wherein the frameworks connecting the implement pulling vehicles are positioned at a height that allows them to straddle fully grown crops so that they be used for late growing season activities such as pulling spray bars or sensors or harvesting implements.

23. The apparatus of claims 1, wherein the implement pulling vehicles are narrow enough to travel in the gaps between crop rows to reduce or eradicate the need for unplanted areas commonly known as tramlines that are left for wider tractor or sprayer or combine harvester tyres to roll over.

24. The apparatus of claims 1, wherein some or all of the frameworks connecting the implement pulling vehicles incorporate pivoting and actuating mechanisms such as cables to facilitate changes in the angle between these components so that the distance between the implement pulling vehicles can be set to match crop row or tramline spacings in different fields and on different farms.

25. The apparatus of claims 24, wherein the pivoting and actuating mechanisms between the implement pulling units accommodate horizontal or vertical misalignment in order to minimise the risk of damage as a result of them moving over uneven ground or implement pulling activity.

26. The apparatus of claims 24, wherein the co-joined implement pulling vehicles would be foldable to enable it to move through narrow openings and along narrow roadways.

27. The apparatus of claims 1, wherein some of the wheels or tracks on the implement pulling vehicle would incorporate height adjustment mechanisms to lift the non rotating and rotating anchors components clear of the ground when the unit is being moved on its wheels.

28. The apparatus of claims 1 to 7, wherein the implement pulling vehicles would incorporate mechanisms to retract both the non rotating and rotating anchors components when the unit is being moved on its wheels.

29. The apparatus of claim 1 or 28, wherein the mechanism used to deploy and retrieve the ground anchors would incorporate a means such as an actuator or cam to twist them in the ground to overcome static friction or suction force before attempting to withdrawing them or whilst withdrawing them.

30. The apparatus used to implement the method of claim 1, wherein to minimise risk of injury or damage the width of the frontal area of the implement pulling vehicles and their interconnecting members is minimised so that a person or animal can easily move out of their way into the space between them.

31. The apparatus used to implement the method of claim 1, wherein to further minimise risk of injury or damage the frontal area of the implement pulling vehicles and interconnecting frameworks and implement are fitted with energy absorbing and deformable components such as shaped foam pieces.

32. The apparatus used to implement the method of claim 1, wherein the winch cables are made from a material with low elasticity and potential energy storage capacity to minimise risk of injury or damage in the event that they break.

33. The apparatus used to implement the method of claim 1, wherein the winch cables would incorporate some longer strands that are not in tension when the cable is pulling the implement such that in the event of a break the longer strands keep the loose ends together and stop them from moving significantly away from the original cable path and causing injury or damage.

34. The apparatus used to implement the method of claim 1, wherein the co-joined implement pulling vehicles are capable of folding to form a trailer unit which can be pulled by a farm tractor or other vehicle.

35. The apparatus used to implement the method of claim 1, wherein the co-joined implement pulling vehicles are capable of folding into a mobile vehicle unit that can move under its own power around a farm or along a road as well as in a field.

36. The apparatus used to implement the method of claim 1, wherein the co-joined implement pulling vehicles use use actuator powered rotation and steering of their wheels or tracks to facilitate folding and unfolding and width adjustment actions.

37. The apparatus used to implement the method of claim 1, wherein the height of the tow bars and towed implements and top up charging vehicle would be minimised to facilitate the farming of crops beneath or within lower height structures than is currently possible.

38. The apparatus used to implement the method of claim 1, wherein the implement pulling vehicles incorporate a multiplicity of internal combustion engines powered by onboard energy stored in liquid or gaseous or solid fuel tanks.

39. The apparatus used to implement the method of claim 1, wherein the co-joined implement pulling vehicles incorporate actuators such as electric motors that are powered by onboard energy storage devices such as batteries or supercapacitors or internal combustion engine powered generators.

40. The apparatus used to implement the method of claim 1, wherein the towed farm implements are drawn up close to and rigidly docked with the implement pulling vehicles and actuators lift the farm implements tools off the ground to enable non linear motion such as that needed to turn around at the end of a set of farm field furrows or generally move around farms or on roads to be undertaken under the vehicles driven wheel power alone.

41. The method of claim 1, wherein in order to fulfil the functionality of the mechanical rotary drive provided on farm tractors to power towed implements that is commonly referred to as a power take off the implement would be fitted with its own electrically powered actuators supplied with energy from either by swappable supercapacitors mounted upon it or via cables from the implement pulling vehicle.

42. The method of claim 1, wherein the vehicle and farm implement are partially or fully electrically powered another manned or autonomous vehicle would deliver charged batteries or supercapacitors to them the vehicle and optionally the implement whilst also removing partially or full discharged units which it would then take to a multiplicity of fixed charging points for recharging.

43. The method of claim 1, wherein supercapacitors or batteries on the implement pulling vehicle are charged up by docking with a multiplicity of mains connected or topped up mobile charging stations that move along a track on a farm field fence.

44. The method of claim 1, wherein the electrical components on the implement are supplied via cables from the towing vehicle or charged up when the two dock together.

45. The method of claim 1, wherein batteries are used to replace or supplement some or all of the supercapacitors used in the solution.

46. The apparatus used to implement the method of claim 1, wherein the implement pulling mechanism comprises of a beam with a multiplicity of ground anchoring units and cable winched mounted along its length that can be fitted to the towing connection of a typical farm tractor or robot or other vehicle.

47. The apparatus used to implement the method of claim 46, wherein the beam is fitted with a multiplicity of wheels along its weight to support some or all of its weight.

48. The apparatus used to implement the method of claim 46, wherein in order to reduce bending moments on the farm tractor or robot or vehicle hitch the a multiplicity of cables fixed to different points along the beam is attached to other points on the farm tractor or robot or vehicle to constrain its rotation about the hitch.

49. The method of claim 46, wherein the farm implement is pulled from a central towing point located along its width by a single cable.

50. The apparatus used to implement the method of claim 46, wherein some pulling force would be provided by a multiplicity of at least two cables attached to the ends of the farm implement whilst a third central cable can be used to pull it inward for docking and optionally also exert towing force where the vehicle is significantly narrower than the implement.

51. The apparatus used to implement the method of claim 46, wherein the cables to constrain the rotation about the hitch would be attached to its extremities of the of the tractor or robot or vehicle to provide optimal leverage against turning moments.

52. The apparatus used to implement the method of claim 46, wherein to clear its wheel or other components the farm tractor or robot or vehicle would be fitted with components such as cross beams to extend the location of extremities further from its axis of travel.

53. The apparatus used to implement the method of claim 46, wherein winch cables on some of pulling vehicles are shortened compared to those on others to enable the pulling of a farm implement along a non linear path where to cope with the change in direction of the pulling force there would be a multiplicity of arms that radiate outward from the main body of the drive unit in different directions with ground anchors fixed to them.

54. The apparatus used to implement the method of claim 46, wherein the implement pulling vehicles have a multiplicity of arms upon which the winches are mounted radiating outward from their body and rigidly fixed to it.

55. The apparatus used to implement the method of claim 46, wherein the implement pulling vehicles have a multiplicity of arms upon which the winches are mounted radiating outward from their body and which can jointly or individually swivel around it.

56. The apparatus used to implement the method of claim 46, wherein the implement pulling vehicles have a multiplicity of winch cable drums that rotate around their body from which the winch cables can be pulled in any direction and optionally additional anchors on the radial arms orientated that act to prevent the rotation of the drive unit bodies or the machine or vehicle to which they are fixed.

57. The apparatus used to implement the method of claim 54 to 56, wherein the implement pulling vehicles have ground anchors on the swivelling arms can be fully retracted by the moving drill mechanism in the all of the different directions in which they were inserted due to the different direction in which all of the arms are pointing.
